(19) United States
(12) Patent Application Publication
(10) Pub. No.: US 2025/0173751 A1
(43) Pub. Date: May 29, 2025

(54) METHOD FOR IDENTIFYING OPTIMAL INFLUENCE CUSTOMER GROUP OF MARKETING NETWORK BASED ON HYPERGRAPH THRESHOLD MODEL

(71) Applicant: DALIAN UNIVERSITY OF TECHNOLOGY, Dalian (CN)

(72) Inventors: Qiang ZHANG, Dalian (CN); Xilong QU, Dalian (CN); Renquan ZHANG, Dalian (CN); Xirong XU, Dalian (CN); Pengfei WANG, Dalian (CN); Tiwei TAO, Dalian (CN)

(21) Appl. No.: 18/629,599

(22) Filed: Apr. 8, 2024

(30) Foreign Application Priority Data
Nov. 27, 2023 (CN) 202311589131.3

(51) Int. Cl. G06Q 30/0204

(52) U.S. Cl. CPC G06Q 30/0204

(57) ABSTRACT

The present invention discloses a method for identifying an optimal influence customer group in a marketing network based on a hypergraph threshold model. The method specifically comprises: step 1: establishing a hypergraph threshold model based on sales data first. Step 2: using the hypergraph threshold model to simulate spread of customer reputation in a marketing network, and setting a hyperedge threshold according to a specific scenario. Step 3: using an HCI-TM algorithm to screen out a most recommendable customer group for popularization, and using a hypergraph threshold rule to simulate spread of information among customers. The present invention proposes a multi-node collective influence measurement method for the hypergraph threshold model, designs the HCI-TM algorithm to efficiently select a maximum influence set, and applies the algorithm in the marketing network at the same time.

### TECHNICAL FIELD

The present invention belongs to the field of computer application, and particularly relates to a method for identifying a most recommendable customer group in a marketing network based on a node collective influence maximization algorithm of a hypergraph threshold model.

### BACKGROUND

How to screen out a most recommendable user group for popularization in a marketing network is of great significance for reducing marketing cost, improving publicity effect, etc. A spreading process in a complex network can be used to describe a variety of phenomena in the real world, including pathophoresis, cascading failure, commodity marketing, etc. Due to heterogeneity of a network structure, some small-scale nodes exist, which play a key role in the spreading process. How to identify the key nodes, i.e., a seed set (a maximum influence set), is of great practical significance. A maximum influence set problem is considered as an NP-hard problem, the purpose of which is to select a fixed number of seed nodes to realize spread maximization, and is widely applied in the fields of product recommendation, public opinion evolution, pathophoresis, etc.

In recent years, much progress has been made in the maximum influence set problem in graphs, and algorithms such as high degree algorithm (HD), PageRank algorithm, eigenvalue based algorithm and CI algorithm have been proposed successively. However, with the continuous progress and development of complex system modeling, people gradually realize that the graphs cannot depict high-order interaction relationships. For example, in the marketing network, high-order interaction relationships exist between multiple customers and multiple products, which cannot be modeled by the graphs. Therefore, hypergraph modeling has become an important direction for complex system modeling. Currently, more and more attention has been paid to the problem of maximum influence set in hypergraphs, and heuristic algorithms such as high degree algorithm and eigenvector algorithm have been proposed successively.

Although certain progress has been made in several solutions proposed by those skilled in the art at present, in real networks such as the marketing network, due to the existence of a rich-club effect, individuals with great influence and strong purchasing power have an aggregation effect, making it difficult to measure the collective influence between multiple nodes and multiple individuals. In the graphs, an effective method at present is to construct a constrained self-satisfying equation of steady-state probability by a Message Passing method, and thereby deriving an influence weight of an individual on a steady state by a dynamical system stability theory. Therefore, the present invention popularizes a Message Passing theoretical analytical framework from the graphs to the hypergraphs, uses a hypergraph threshold model to describe an information spreading rule in real scenarios such as the marketing network, proposes a multi-node collective influence measurement method, designs an HCI-TM algorithm based on a greedy strategy to select the seed set (customer group) with the maximum influence, verifies robustness and effectiveness of the algorithm by numerical simulation, founds that the index of hypergraph collective influence can be used for predicting the occurrence of cascade phenomenon, and finally applies the method to a real marketing network, which can screen out a most recommendable customer group.

### SUMMARY

The purpose of the present invention is to propose a node collective influence measurement method based on a hypergraph threshold model, design an HCI-TM algorithm to select a seed set with the maximum influence in a hypergraph, use the hypergraph threshold model to simulate spread of reputation among customers in a marketing network, apply the HCI-TM algorithm to the marketing network to identify a most recommendable customer group, and form a method for identifying a recommendable customer group in a marketing network based on a node collective influence maximization algorithm of a hypergraph threshold model.

The technical solution to achieve the above purpose:

A method for identifying an optimal influence customer group in a marketing network based on a hypergraph threshold model, comprising the following steps:
Step 1: establishing a hypergraph threshold model based on sales data first.
Step 2: using the hypergraph threshold model to simulate spread of customer reputation in a marketing network, and setting a hyperedge threshold according to a specific scenario.
Step 3: using an HCI-TM algorithm to screen out a most recommendable customer group for popularization, and using a hypergraph threshold rule to simulate spread of information among customers.

Further, a process of establishing the hypergraph threshold model in step 1 is as follows:

In the hypergraph threshold model, each node represents a customer, each hyperedge represents an interaction relationship between the customer and a product, and one hyperedge represents an interaction relationship between all customers who have evaluated a certain product and the product; a specific rule of the hypergraph threshold model is that when the node activation ratio in a hyperedge exceeds the hyperedge threshold, the hyperedge will be activated; when a hyperedge is activated, all nodes in the hyperedge will be activated.

A Cavity method is used to establish a conditional probability self-satisfying equation based on the hypergraph threshold rule, thus to weaken strong correlation between the nodes and the hyperedge and accurately describe an information spreading rule in a hypergraph. The self-satisfying equation described in a tree-like hypergraph is expressed as formula (1), i.e., a condition for activating node i is that: the node will be activated when any hyperedge incident with the node other than a hyperedge e_{γ} is activated, and a condition for activating the hyperedge e_{γ} is that: the hyperedge will be activated when any m_{γ} nodes incident with the hyperedge e_{γ} other than the node i are activated:

$$\{ \begin{matrix}{v}_{i \to {e}_{γ}} = {n}_{i} + ( 1 - {n}_{i} ) [ 1 - {\prod }_{{e}_{β} ∈ \partial {ile}_{γ}} ( 1 - {v}_{{e}_{β} \to i} ) ] \\ {v}_{{e}_{γ} \to i} = 1 - {\prod }_{{P}_{h} ∈ {P}_{{e}_{γ} li}^{{m}_{γ}}} ( 1 - {\prod }_{p ∈ {P}_{h}} {v}_{p \to {e}_{γ}} )\end{matrix} \qquad ( 1 )$$

In formula (1), v_{i→e}_{_{γ}} represents the probability that the node i is activated when the hyperedge e_{γ} is removed, and Vₑ_{_{γ}}_{→i} represents the probability that the hyperedge e_{γ} is activated when the node i is removed; ∂i/e_{γ} represents a set composed of hyperedges incident with the node i other than the hyperedge e_{γ}; a set of all combinatorial numbers composed of m_{γ} nodes in the hyperedge e_{γ} other than the node i is Pₑ_{_{γ}}_{/i}^{m}^{_{γ}}, Pₑ_{_{γ}}_{/i}^{m}^{_{γ}}={P₁, P₂, . . . , P_{τ}}, where τ=C_{N}_{_{γ}}₋₁^{m}^{_{γ}}, Pₕ∈Pₑ_{_{γ}}_{/i}^{m}^{_{γ}}, and Pₕ={Pₕ₁, Pₕ₂, . . . , Pₕₘ_{_{γ}}} represents a set composed of m_{γ} nodes. nᵢ represents whether the node i is a seed node; when the node is a seed node, nᵢ=1; otherwise, nᵢ=0.

Final states of the node i and the hyperedge e_{γ} can be calculated by the following formula:

$$\{ \begin{matrix}{v}_{i} = {n}_{i} + ( 1 - {n}_{i} ) [ 1 - {\prod }_{{e}_{β} ∈ \partial i} ( 1 - {v}_{{e}_{β} \to i} ) ] \\ {v}_{{e}_{γ}} = 1 - {\prod }_{{P}_{h} ∈ {P}_{{e}_{γ}}^{{m}_{γ}}} ( 1 - {\prod }_{p ∈ {P}_{h}} {v}_{p \to {e}_{γ}} )\end{matrix} \qquad ( 2 )$$

In formula (2), vᵢ represents the final state of the node i, and vₑ_{_{γ}} represents the final state of the hyperedge e_{γ}.

A method for calculating hypergraph collective influence is as follows:

To simplify formula (1), letting V_{→}={v₁, V₂}^{T}, where v₁={v_{i→e}_{_{γ}}}_{S×1}, and v₂={vₑ_{_{γ}}_{→i}}_{S×1}. S=Σᵢ₌₁^{N}kᵢ represents the sum of hyperdegrees of all nodes. Similarly, n is popularized to higher dimensions

$${n}_{\to } = {( {n}_{1} , 0 )}^{T} = {( {{\underbrace{… , \overbrace{{n}_{i} , … , {n}_{i}} , …}}_{S}}^{{k}_{i}} , {\underbrace{0 , … , 0}}_{S}^{} )}^{T} \qquad ( 3 )$$

Therefore, formula (1) can be simplified as:

$${V}_{\to } = {n}_{\to } + G ( {V}_{\to } ) ⇔ \{ \begin{matrix}{v}_{1} = {n}_{1} + {g}_{1} ( {v}_{2} ) \\ {v}_{2} = 0 + {g}_{2} ( {v}_{1} )\end{matrix} \qquad ( 4 )$$

Where g₁(v₂) represents a nonlinear function of v₂, and g₂(v₁) represents a nonlinear function of v₁;

As formula (4) is composed of complex nonlinear equations, which cannot be solved directly, linearization and a fixed point iteration method are used to solve formula (4):

$${V}_{\to }^{t + 1} = {n}_{\to } + J G {\vert}_{{v}_{\to }^{t}} \times {V}_{\to }^{t} \qquad ( 5 )$$

Where V_{→}^{t} represents a state of V_{→} when the number of iteration steps is t;

A specific form of a Jacobian matrix J [symbol] |_{V}_{_{→}}_{^{t}} is solved as follows:

$$𝒥𝒢 = {( \begin{matrix}\frac{\partial {g}_{1}}{\partial {v}_{1}} & \frac{\partial {g}_{1}}{\partial {v}_{2}} \\ \frac{\partial {g}_{2}}{\partial {v}_{1}} & \frac{\partial {g}_{2}}{\partial {v}_{2}}\end{matrix} )}_{2 S \times 2 S} \qquad ( 6 )$$

A partial derivative of g₁ is calculated:

$$\frac{\partial {v}_{i \to {e}_{γ}}}{\partial {v}_{i \to {e}_{β}}} = 0 \qquad ( 7 )$$

$$\frac{\partial {v}_{i \to {e}_{γ}}}{\partial {v}_{{e}_{β} \to j}} {\vert}_{{v}_{\to }^{t}} = \{ \begin{matrix}1 - {n}_{i} & i = j , {e}_{β} \neq {e}_{γ} , {a}_{{e}_{β} \to i , i \to {e}_{γ}}^{t} = 0 \\ 0 & otherwise\end{matrix} \qquad ( 8 )$$

Where aₑ_{_{β}}_{→i,i→e}_{_{γ}}^{t}=Σₑ_{_{μ}}_{∈∂i/(e}_{_{γ}}_{,e}_{_{β}}₎vₑ_{_{μ}}_{→i}^{t}.

A partial derivative of g₂ is calculated as follows:

$$\frac{\partial {v}_{{e}_{γ} \to i}}{\partial {v}_{{e}_{β} \to j}} = 0 \qquad ( 9 )$$

When e_{β}=e_{γ}, j≠i:

$$\frac{\partial {v}_{{e}_{γ} \to i}}{\partial {v}_{j \to {e}_{γ}}} = {{\prod }_{{P}_{h} ∉ {P}_{{e}_{γ} li}^{{m}_{γ}}}}_{j ∉ {P}_{h}} ( 1 - {\prod }_{p ∈ {P}_{h}} {v}_{p \to {e}_{γ}} ) {{\sum }_{{P}_{h} ∈ {P}_{{e}_{γ} li}^{{m}_{γ}}}}_{j ∈ {P}_{h}} [ {\prod }_{P ∈ {P}_{h} / j} {v}_{p \to {e}_{γ}} {{{\prod }_{{\tilde{P}}_{h} ∈ {P}_{{e}_{γ} li}^{{m}_{γ}}}}_{{\tilde{P}}_{h} \neq {P}_{h}}}_{j ∈ {\tilde{P}}_{h}} ( 1 - {\prod }_{p ∈ {\tilde{P}}_{h}} {v}_{p \to {e}_{γ}} ) ] \qquad ( 10 )$$

Where \tilde{P}ₕ∈Pₑ_{_{γ}}_{/i}^{m}^{_{γ}} and \tilde{P}ₕ≠Pₕ.

Letting b_{j→e}_{_{γ}}_{,e}_{_{γ}}_{→i}^{t}=Σ_{p∈∂e}_{_{γ}}_{/(i,j)}v_{p→e}_{_{γ}}^{t} represent the number of nodes activated at time t in e_{γ} after nodes i and j are removed. When b_{j→e}_{_{γ}}_{,e}_{_{γ}}_{→i}^{t}≥m_{γ}, Π_{p∈P}_{ₕ}v_{p→e}_{_{γ}}=1 certainly exists, so

$$\frac{\partial {v}_{{e}_{γ} \to i}}{\partial {v}_{j \to {e}_{γ}}} = 0 .$$

When b_{j→e}_{_{γ}}_{,e}_{_{γ}}_{→i}^{t}≤m_{γ}−2, any Π_{p∈P}_{ₕ} v_{p→e}_{_{γ}} is 0, so

$$\frac{\partial {v}_{{e}_{γ} \to i}}{\partial {v}_{j \to {e}_{γ}}} = 0 .$$

When b_{j→e}_{_{γ}}_{,e}_{_{γ}}_{→i}^{t}≤m_{γ}−1, exactly and only one combination makes Π_{p∈P}_{ₕ}_{/j}v_{p→e}_{_{γ}}=1, then

$${\prod }_{\begin{matrix}{\tilde{P}}_{h} ∈ {P}_{{e}_{γ} / i}^{{m}_{γ}} \\ {\tilde{P}}_{h} \neq {P}_{h} \\ j ∈ {\tilde{P}}_{h}\end{matrix}} ( 1 - {\prod }_{p ∈ {\tilde{P}}_{h}} {v}_{p \to {e}_{γ}} ) = 1 , \\ {\prod }_{\begin{matrix}{P}_{h} ∈ {P}_{{e}_{γ} / i}^{{m}_{γ}} \\ j ∉ {P}_{h}\end{matrix}} ( 1 - {\prod }_{p ∈ {P}_{h}} {v}_{p \to {e}_{γ}} ) = 1 , so \frac{\partial {v}_{{e}_{γ} \to i}}{\partial {v}_{j \to {e}_{γ}}} = 1.$$

### Therefore:

$$\frac{\partial {v}_{{e}_{γ} \to i}}{\partial {v}_{j \to {e}_{β}}} {\vert}_{{V}_{\to }^{i}} = \{ \begin{matrix}1 & {e}_{β} = {e}_{γ} , j \neq i , {b}_{j \to {e}_{γ} , {e}_{γ} \to i}^{t} = {m}_{γ} - 1 \\ 0 & otherwise\end{matrix} \qquad ( 11 )$$

As a result, the specific form of the Jacobian matrix J [symbol] _{V}_{_{→}}_{^{t}} is:

$$JG {\vert}_{{V}_{\to }^{t}} = ( \begin{matrix}0 & {M}^{t} \\ {I}^{t} & 0\end{matrix} ) \qquad ( 12 )$$

Where

$${ℳ}^{t} = \{ {ℳ}_{{e}_{β} \to j , i \to {e}_{γ}}^{t} \} = \{ \frac{\partial {v}_{i \to {e}_{γ}}}{\partial {v}_{{e}_{β} \to j}} \} {\vert}_{{V}_{\to }^{t}}$$

is a non-backtracking matrix, and

$${𝒥}^{t} = \{ {𝒥}_{j \to {e}_{β} , {e}_{γ} \to i} \} {\vert}_{{V}_{\to }^{t}} = \{ \frac{\partial {v}_{{e}_{γ} \to i}}{\partial {v}_{j \to {e}_{β}}} \} {\vert}_{{V}_{\to }^{t}}$$

is a subcritical non-backtracking matrix. For the convenience of subsequent iterative derivation, the non-backtracking matrix [symbol] and the subcritical non-backtracking matrix [symbol] are extended to higher dimensions:

$$\{ \begin{matrix}{M}_{{e}_{β} {jie}_{γ}}^{t} = ( 1 - {n}_{i} ) {H}_{{ie}_{γ}} {H}_{{je}_{β}} {δ}_{ij} ( 1 - {δ}_{{e}_{β} {e}_{γ}} ) {M}_{{e}_{β} {iie}_{γ}}^{t} \\ {I}_{{je}_{β} {e}_{γ} i}^{t} = {H}_{{ie}_{γ}} {H}_{{je}_{β}} {δ}_{{e}_{β} {e}_{γ}} ( 1 - {δ}_{ij} ) {I}_{{je}_{γ} {e}_{γ} i}^{t}\end{matrix} \qquad ( 13 )$$

Where [symbol] represents an element with a subscript (e_{β},j, i, e_{γ}) in a 4-dimensional tensor { [symbol] }_{M×N×N×M}; when i=j, δᵢⱼ=1; otherwise, δᵢⱼ=0. [symbol] represents an element with a subscript (j, e_{β}, e_{γ}, i) in a 4-dimensional tensor { [symbol] }_{N×M×M×N}; H={Hᵢₑ_{_{γ}}}_{S×S} is an incidence matrix; when the node i is incident with the hyperedge e_{γ}, Hᵢₑ_{_{γ}}=1; otherwise, Hᵢₑ_{_{γ}}=0. When aₑ_{_{β}}_{→i,i→e}_{_{γ}}^{t}=0, Mₑ_{_{β}}ᵢᵢₑ_{_{γ}}^{t}=1; otherwise, Mₑ_{_{β}}ᵢᵢₑ_{_{γ}}^{t}=0. Similarly, when b_{j→e}_{_{γ}}_{,e}_{_{γ}}_{→i}^{t}=m_{γ}−1, Iⱼₑ_{_{γ}}ₑ_{_{γ}}ᵢ^{t}=1; otherwise, Iⱼₑ_{_{γ}}ₑ_{_{γ}}ᵢ^{t}=0.

The fixed point iteration method is used to iterate formula (5) as follows:

When t=1, letting V_{→}⁰=n_{→} and V_{→}¹=n_{→}+J [symbol] ×n_{→}:

$${[ \begin{matrix}{v}_{1} \\ {v}_{2}\end{matrix} ]}^{1} = [ \begin{matrix}{n}_{1} \\ 0\end{matrix} ] + [ \begin{matrix}0 & {M}^{0} \\ {I}^{0} & 0\end{matrix} ] [ \begin{matrix}{n}_{1} \\ 0\end{matrix} ] = [ \begin{matrix}{n}_{1} \\ {I}^{0} {n}_{1}\end{matrix} ] \qquad ( 14 )$$

A specific form of each element in formula (14) can be expressed as:

$$\{ \begin{matrix}{v}_{i \to {e}_{γ}}^{1} = {n}_{i} {H}_{{ie}_{γ}} \\ {v}_{{e}_{γ} \to i}^{1} = {H}_{{ie}_{γ}} {\sum }_{j} {n}_{j} {H}_{{je}_{γ}} ( 1 - {δ}_{ij} ) {I}_{{je}_{γ} {e}_{γ} i}^{0}\end{matrix} \qquad ( 15 )$$

A 1-norm of an activation probability v is used to measure a final activation scale in hypergraphs, and the following formula is obtained after collation:

$$\begin{matrix}‖ {v}_{\to } ‖ = {\sum }_{{ie}_{γ}} {v}_{i \to {e}_{γ}} + {\sum }_{{ie}_{γ}} {v}_{{e}_{γ} \to i} \\ = {\sum }_{{ie}_{γ}} {n}_{i} {H}_{{ie}_{γ}} + {\sum }_{{ie}_{γ}} {H}_{{ie}_{γ}} {\sum }_{j} {n}_{j} {H}_{{je}_{γ}} ( 1 - {δ}_{ij} ) {I}_{{je}_{γ} {e}_{γ} i}^{0} \\ = {\sum }_{i} {n}_{i} {k}_{i} + {\sum }_{i} {n}_{i} {\sum }_{{e}_{γ} ∈ \partial i} {\sum }_{j ∈ \partial {e}_{γ} / i} {I}_{{ie}_{γ} {e}_{γ} j}^{0} \\ = {\sum }_{i} {n}_{i} ( {k}_{i} + {\sum }_{{e}_{γ} ∈ \partial i} {\sum }_{j ∈ \partial {e}_{γ} / i} {I}_{{ie}_{γ} {e}_{γ} j}^{0} )\end{matrix} \qquad ( 16 )$$

By selecting the node i with the maximum kᵢ+Σₑ_{_{γ}}_{∈∂i}Σ_{j∈∂e}_{_{γ}}_{/i} Iᵢₑ_{_{γ}}ₑ_{_{γ}}ⱼ⁰ value as a seed, the minimum number of seed sets can be selected to realize information spread maximization. Therefore, 1-order hypergraph collective influence is defined:

$${HCI}_{1} ( i ) = {k}_{i} + {\sum }_{{e}_{γ} ∈ \partial i} {\sum }_{j ∈ \partial {e}_{γ} / i} {I}_{{ie}_{γ} {e}_{γ} j}^{0} \qquad ( 17 )$$

Using the above method, when t=2 and V_{→}²=n_{→}+j [symbol] ×V_{→}¹, 2-order hypergraph collective influence can be derived:

$${HCI}_{2} ( i ) = {k}_{i} + {\sum }_{{e}_{γ} ∈ \partial i} {\sum }_{j ∈ \partial {e}_{γ} / i} {I}_{{ie}_{γ} {e}_{γ} j}^{1} + {\sum }_{{e}_{γ} ∈ \partial i} {\sum }_{j ∈ \partial {e}_{γ} / i} {I}_{{ie}_{γ} {e}_{γ} j}^{0} {\sum }_{{e}_{μ} ∈ \partial j / {e}_{γ}} ( 1 - {n}_{j} ) {M}_{{e}_{γ} {jje}_{μ}}^{1} \qquad ( 18 )$$

Similarly, n-order hypergraph collective influence can be derived as:

$${HCI}_{n} ( i ) = {k}_{i} + {\sum }_{L ∈ {A}_{n}} {O}_{L}^{n} + {\sum }_{L ∈ {B}_{n}} {E}_{L}^{n} \qquad ( 19 )$$

Where Aₙ={x∈N⁺|x mod 2=0,x≤n} and Bₙ={x∈N⁺|x mod 2=1, x≤n}.

$$\begin{matrix}{𝕆}_{L}^{n} = {\sum }_{{e}_{γ} ∈ \partial i} {\sum }_{{i}_{1} ∈ \partial {e}_{γ} / i} {I}_{{ie}_{γ} {e}_{γ} {i}_{1}}^{n - L} {\sum }_{{e}_{{γ}_{1}} ∈ \partial {i}_{1} / {e}_{γ}} ( 1 - {n}_{{i}_{1}} ) {M}_{{e}_{γ} {i}_{1} {i}_{1} {e}_{{γ}_{1}}}^{n - L + 1} \times … \times {\sum }_{{e}_{{γ}_{ℓ}} ∈ \partial {i}_{ℓ} / {e}_{{γ}_{ℓ - 1}}} ( 1 - {n}_{{i}_{ℓ}} ) {M}_{{e}_{{γ}_{ℓ - 1}}}^{n - 1} {i}_{ℓ} {i}_{ℓ} {e}_{{γ}_{ℓ}} , \\ {𝔼}_{L}^{n} = {\sum }_{{e}_{γ} ∈ \partial i} {\sum }_{{i}_{1} ∈ \partial {e}_{γ} / i} {I}_{{ie}_{γ} {e}_{γ} {i}_{1}}^{n - L} {\sum }_{{e}_{{γ}_{1}} ∈ \partial {i}_{1} / {e}_{γ}} ( 1 - {n}_{{i}_{1}} ) {M}_{{e}_{γ} {i}_{1} {i}_{1} {e}_{{γ}_{1}}}^{n - L + 1} \times … \times {\sum }_{{i}_{ι} ∈ \partial {e}_{{γ}_{ι}} / {i}_{ι}} {I}_{{i}_{ι} {e}_{{γ}_{ι}} {e}_{{γ}_{ι}} {i}_{ι + 1}}^{n - 1} .\end{matrix}$$

Where i₁ represents a 1-layer neighbor node of the node i; [symbol] represents an [symbol] -layer neighbor node of the node i; e_{γ}_{₁} represents a 1-layer neighbor hyperedge of the hyperedge e_{γ}; [symbol] represents an [symbol] -layer neighbor hyperedge of the hyperedge e_{γ};

Further, a design method of the HCI-TM algorithm (a greedy algorithm for selecting a set with the maximum influence) in step 3 is as follows:
Step 1: initializing a seed set S=Ø, and calculating the n-order hypergraph collective influence HCIₙ(i) of all nodes in the hypergraph.
Step 2: selecting the node i with the maximum n-order hypergraph collective influence as a seed, adding the seed into a seed set S={i}∪S, and then conducting spread based on the hypergraph threshold rule;
Step 3: judging whether the node activation ratio in the hypergraph exceeds aᵣ; if the node activation ratio exceeds aᵣ, the maximum influence set in this condition is S;
Step 4: if the node activation ratio does not exceed aᵣ, recalculating the n-order hypergraph collective influence HCIₙ(i) of a ┌n/2┐-layer neighbor node of an active node, and repeating step 2 to step 3.

Robustness and effectiveness of the HCI-TM algorithm are verified on Erdös-Rényi hypergraphs with the average hyperdegrees of 2 and 3, scale-free hypergraphs with the power-law exponents of 1.5 and 2, and uniform hypergraphs with the cardinalities of hyperdegree of 4 and 5. Specific steps are as follows:
Step 1: using a configuration model to generate the Erdös-Rényi hypergraphs, the scale-free hypergraphs and the uniform hypergraphs with different parameter settings.
Step 2: using the HCI-TM algorithm and other contrast algorithms to select seed sets on different types of hypergraphs, conducting spread based on the threshold rule, and recording the activation scale in hypergraphs at a fixed interval (ratio of seed nodes).
Step 3: making a comparison with other algorithms to evaluate the effectiveness of the HCI-TM algorithm: when a same ratio of seed nodes is selected, the algorithm with a larger activation scale in hypergraphs is more effective.

By analyzing the evolution of the maximum HCI value in the hypergraphs in a seed selection process, it is verified that the index of hypergraph collective influence can be used as a criterion for predicting the occurrence of cascade phenomenon. Specific steps thereof are as follows:
Step 1: using the HCI-TM algorithm to select the seed nodes on the hypergraphs, and recording the HCI value of the selected seed nodes (the maximum HCI value in the hypergraphs at the moment).
Step 2: analyzing the figure of the evolution of the HCI value with the selection of the seed nodes; the index of HCI can be used as a criterion for predicting the occurrence of cascade phenomenon: the peak value of HCI is corresponding to a phase transformation point where the cascade phenomenon occurs; by observing the evolution of the maximum HCI value in the hypergraphs, whether and when the cascade phenomenon will occur in a hypergraph spreading process can be judged.

Compared with the prior art, the present invention has the following beneficial effects:
(1) The present invention popularizes a Message Passing theoretical analytical framework from the graphs to the hypergraphs, uses the hypergraph threshold model to simulate the spread of information in real scenarios such as the marketing network, and proposes a multi-node collective influence measurement method by analyzing the self-satisfying equation that satisfies the threshold rule.
(2) The present invention designs a greedy algorithm for selecting a set with the maximum influence (the HCI-TM algorithm) based on a hypergraph collective influence measurement method; the algorithm has strong robustness and effectiveness, and is applied in the marketing network.
(3) The present invention provides the criterion for predicting the occurrence of hypergraph cascade phenomenon based on the concept of hypergraph collective influence.

### DESCRIPTION OF DRAWINGS

FIG. 1 is a flow chart of the present invention.

FIG. 2 is a schematic diagram of a hypergraph threshold rule of the present invention; ovals represent hyperedges, and circles represent nodes.

FIG. 3 is a schematic diagram of hypergraph collective influence of the present invention; a is a schematic diagram of 1-order hypergraph collective influence, and b is a schematic diagram of 2-order hypergraph collective influence. Circles represent nodes, triangles represent hyperedges, connected edges indicate that incidence relationships exists between the hyperedges and the nodes, triangles with rhombuses indicate that the hyperedges are in a subcritical state, i.e., in a hyperedge e_{γ}, m_{γ}−1 nodes have already been activated.

FIG. 4 shows the performance of a HCI-TM algorithm of the present invention and other algorithms on generated hypergraphs under different parameter settings; each horizontal axis q is the ratio of seed nodes, and each vertical axis Q(q) is the activation ratio of nodes in the hypergraphs when the seed nodes with a ratio q is selected. a-d represent the performance of the algorithms on Erdös-Rényi hypergraphs with the average hyperdegrees of 2 and 3 and the hypergraph scales of 10,000 and 100,000; e-h represent the performance of the algorithms on scale-free hypergraphs with the power-law exponents of 1.5 and 2 and the hypergraph scales of 10,000 and 100,000; i−1 represent the performance of the algorithms on uniform hypergraphs with the cardinalities of hyperdegree of 4 and 5 and the hypergraph scales of 10,000 and 100,000.

FIG. 5 shows actual time complexity analysis of a HCI-TM algorithm of the present invention and other algorithms on hypergraphs. Each horizontal axis is log₁₀ N, where N is the hypergraph scale. Each vertical axis is log₁₀ T, where T is the operating time. a and d represent the actual time complexity analysis on Erdös-Rényi hypergraphs with the average hyperdegrees of 2 and 3, respectively; b and e represent the actual time complexity analysis on scale-free hypergraphs with the power-law exponents of 1.5 and 2; and c and f represent the actual time complexity analysis on uniform hypergraphs with the cardinalities of hyperdegree of 4 and 5.

FIG. 6 is the figure of the evolution of the maximum HCI value in hypergraphs of the present invention with the selection of seed nodes. a represents the figure of the evolution of the maximum HCI value in hypergraphs on an Erdös-Rényi hypergraph with the average hyperdegree of 3 and the hypergraph scale of 10,000; b represents the figure of the evolution of the maximum HCI value in hypergraphs on a scale-free hypergraph with the power-law exponent of 1.5 and the hypergraph scale of 10,000; c represents the figure of the evolution of the maximum HCI value in hypergraphs on a uniform hypergraph with the cardinality of hyperdegree of 5 and the hypergraph scale of 10,000.

FIG. 7 shows the performance of a HCI-TM algorithm of the present invention and other contrast algorithms on a marketing network (a Las Vegas bar review dataset).

### DETAILED DESCRIPTION

In order to describe the present invention more specifically, the technical solution of the present invention will be described below in detail in combination with the drawings and specific embodiments.

Firstly, in a study process of the node collective influence measurement method of the hypergraph threshold model, the solution uses the hypergraph threshold model to simulate the information spreading rule in real scenarios such as the marketing network, each node represents a customer or individual in the real scenarios, each hyperedge represents a high-order interaction relationship between individuals, and a specific rule of the hypergraph threshold model is that when the node activation ratio in a hyperedge exceeds the hyperedge threshold, the hyperedge will be activated; when a hyperedge is activated, all nodes in the hyperedge will be activated.

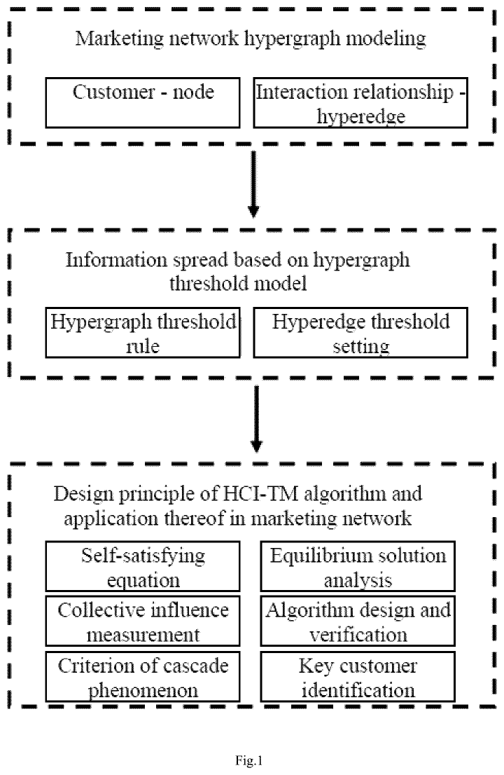

FIG. 1 is taken as an example to describe a hypergraph threshold rule. All hyperedge thresholds in the hypergraph are set to 0.5; when the initial t=0, node 3 is selected as a seed node; at this time, an active node and hyperedge set U(0)={3}. When t=1, the hyperedge e_{γ2} and the hyperedge e_{γ3} reach the thresholds and are activated, and U(1)={3, e_{γ2}, e_{γ3}}. When t=2, the activation of the hyperedge e_{γ2} and the hyperedge e_{γ3} causes node 2 and node 6 to be activated, and U(2)={3, e_{γ2}, e_{γ3}, 2,6}. When t=3, the hyperedge e_{γ1} and the hyperedge e_{γ5} are activated, and U(3)={3, e_{γ2}, e_{γ3}, 2,6, e_{γ1}, e_{γ5}}. At the next moment, node 1 and node 7 are activated, and U(4)={3, e_{γ2}, e_{γ3}, 2,6, e_{γ1}, e_{γ5}, 1,7}. Finally, no new hyperedge or node can be activated, and the spreading process is stopped.

Secondly, a Cavity method is used to establish a conditional probability self-satisfying equation based on the hypergraph threshold rule, thus to weaken strong correlation between the nodes and the hyperedges and more accurately describe an information spreading rule in a hypergraph. With respect to the self-satisfying equation, a condition for activating node i is that the node will be activated when any hyperedge incident with the node other than a hyperedge e_{γ} is activated, and a condition for activating the hyperedge e_{γ} is that the hyperedge will be activated when any m_{γ} nodes incident with the hyperedge e_{γ} are activated:

$$\text{?} \qquad ( 1 )$$

$$\text{?} \text{indicates text missing or illegible when filed}$$

Final states of the node i and the hyperedge e_{γ} can be calculated by the following formula:

$$\{ \begin{matrix}{v}_{i} = {n}_{i} + ( 1 - {n}_{i} ) [ 1 - {\prod }_{{e}_{β} ∈ \partial i} ( 1 - {v}_{{e}_{β} \to i} ) ] \\ {v}_{{e}_{γ}} = 1 - {\prod }_{{P}_{h} ∈ {P}_{{e}_{γ}}^{{m}_{γ}}} ( 1 - {\prod }_{p ∈ {P}_{h}} {v}_{p \to {e}_{γ}} )\end{matrix} \qquad ( 2 )$$

In formula (2), vᵢ represents the final state of the node i, and vₑ_{_{γ}} represents the final state of the hyperedge e_{γ}.

To simplify formula (1), letting V_{→}={v₁, v₂}^{T}, where vᵢ {V_{i→e}_{_{γ}}}_{S×1}, and v₂={vₑ_{_{γ}}_{→i}}_{S×1}. S=Σᵢ₌₁^{N} kᵢ represents the sum of hyperdegrees of all nodes. Similarly, n is popularized to higher dimensions

$${n}_{\to } = {( {n}_{1} , 0 )}^{T} = {( {\underbrace{… , {\overbrace{{n}_{i} , … , {n}_{i}}}^{{k}_{i}} , …}}_{S} , {\underbrace{0 , … , 0}}_{S} )}^{T} \qquad ( 3 )$$

Therefore, formula (1) can be simplified as:

$${V}_{\to } = {n}_{\to } + G ( {V}_{\to } ) ⇔ \{ \begin{matrix}{v}_{1} = {n}_{1} + {g}_{1} ( {v}_{2} ) \\ {v}_{2} = 0 + {g}_{2} ( {v}_{1} )\end{matrix} \qquad ( 4 )$$

As formula (3) is composed of complex nonlinear equations, which cannot be solved directly, linearization and a fixed point iteration method are used to solve formula (3):

$${V}_{\to }^{t + 1} = {n}_{\to } + JG {\vert}_{{V}_{\to }^{t}} \times {V}_{\to }^{t} \qquad ( 5 )$$

A specific form of a Jacobian matrix J [symbol] |_{V}_{_{→}}_{^{t}} is solved as follows:

$$J = {( \begin{matrix}\frac{\partial {g}_{1}}{\partial {v}_{1}} & \frac{\partial {g}_{1}}{\partial {v}_{2}} \\ \frac{\partial {g}_{2}}{\partial {v}_{1}} & \frac{\partial {g}_{2}}{\partial {v}_{2}}\end{matrix} )}_{2 S \times 2 S} \qquad ( 6 )$$

A partial derivative of g₁ is calculated:

$$\frac{\partial {v}_{i \to {e}_{γ}}}{\partial {v}_{j \to {e}_{β}}} = 0 \qquad ( 7 )$$

$$\frac{\partial {v}_{i \to {e}_{γ}}}{\partial {v}_{{e}_{β} \to j}} {\vert}_{{V}_{\to }^{t}} = \{ \begin{matrix}1 - {n}_{i} & i = j , {e}_{β} \neq {e}_{γ} , {a}_{{e}_{β} \to i , i \to {e}_{γ}}^{t} = 0 \\ 0 & otherwise\end{matrix} \qquad ( 8 )$$

Where aₑ_{_{β}}_{→i,i→e}_{_{γ}}^{t}=Σₑ_{_{μ}}_{∈∂i/(e}_{_{γ}}_{,e}_{_{β}}₎vₑ_{_{μ}}_{→i}^{t}.

A partial derivative of g₂ is calculated as follows:

$$\frac{\partial {v}_{{e}_{γ} \to i}}{\partial {v}_{{e}_{β} \to j}} = 0 \qquad ( 9 )$$

When e_{β}=e_{γ}, j≠i:

$$\frac{\partial {v}_{{e}_{γ} \to i}}{\partial {v}_{j \to {e}_{γ}}} = {{\prod }_{{P}_{h} ∈ {P}_{{e}_{γ / i}}^{{m}_{γ}}}}_{j ∉ {P}_{h}} ( 1 - {\prod }_{p ∈ {P}_{h}} {v}_{p \to {e}_{γ}} ) {{\sum }_{{P}_{h} ∈ {P}_{{e}_{γ / i}}^{{m}_{γ}}}}_{j ∈ {P}_{h}} [ {\prod }_{p ∈ {P}_{h} / j} {v}_{p \to {e}_{γ}} {{{\prod }_{{\tilde{P}}_{h} ∈ {P}_{{e}_{γ / i}}^{{m}_{γ}}}}_{{\tilde{P}}_{h} \neq {P}_{h}}}_{j ∈ {\tilde{P}}_{h}} ( 1 - {\prod }_{p ∈ {\tilde{P}}_{h}} {v}_{p \to {e}_{γ}} ) ] \qquad ( 10 )$$

Letting b_{j→e}_{_{γ}}_{, e}_{_{γ}}_{→i}^{t}=p_{∈∂e}_{_{γ}}_{/(i,j)} v_{p→e}_{_{γ}}^{t} represent the number of nodes activated at time t in e_{γ} after nodes i and j are removed. When b_{j→e}_{_{γ}}_{,e}_{_{γ}}_{→i}^{t}≤m_{γ}, Π_{p∈P}_{ₕ} v_{p→e}_{_{γ}}=1 certainly exists, so

$$\frac{\partial {v}_{{e}_{γ} \to i}}{\partial {v}_{j \to {e}_{γ}}} = 0.$$

When bₑ_{_{β}}_{→i,i→e}_{_{γ}}^{t}≤m_{γ}−2, any Π_{p∈P}_{ₕ} v_{p→e}_{_{γ}}=1 is 0, so

$$\frac{\partial {v}_{{e}_{γ} \to i}}{\partial {v}_{j \to {e}_{γ}}} = 0.$$

When bₑ_{_{β}}_{→i,i→e}_{_{γ}}^{t}≤m_{γ}−1, exactly and only one combination makes Π_{p∈P}_{ₕ} v_{p→e}_{_{γ}}=1, then

$${\prod }_{{{{\overline{P}}_{h} ∈ {P}_{{e}_{γ / i}}^{{m}_{γ}}}_{{\overline{P}}_{h} \neq {P}_{h}}}_{j ∈ {\overline{P}}_{h}}} ( 1 - {\prod }_{p ∈ {\overline{P}}_{h}} {v}_{p \to {e}_{γ}} ) = 1 ,$$

$${\prod }_{{{P}_{h} ∈ {P}_{{e}_{γ / i}}^{{m}_{γ}}}_{j ∉ {P}_{h}}} ( 1 - {\prod }_{p ∈ {P}_{h}} {v}_{p \to {e}_{γ}} ) = 1 , so \frac{\partial {v}_{{e}_{γ} \to i}}{\partial {v}_{j \to {e}_{γ}}} = 1.$$

### Therefore:

$$\frac{\partial {v}_{{e}_{γ} \to i}}{\partial {v}_{j \to {e}_{β}}} {\vert}_{{V}_{\to }^{t}} = \{ \begin{matrix}1 & {e}_{β} = {e}_{γ} , j \neq i , {b}_{j \to {e}_{γ} , {e}_{γ} \to i}^{t} = {m}_{γ} - 1 \\ 0 & otherwise\end{matrix} \qquad ( 11 )$$

As a result, the specific form of the Jacobian matrix J [symbol] |_{V}_{_{→}}_{^{t}} is:

$$JG {\vert}_{{V}_{\to }^{t}} = ( \begin{matrix}0 & {M}^{t} \\ {I}^{t} & 0\end{matrix} ) \qquad ( 12 )$$

Where

$${t}^{} = \{ {{e}_{β} \to j , i \to {e}_{γ}}_{t}^{} \} = \{ \frac{\partial {v}_{i \to {e}_{γ}}}{\partial {v}_{{e}_{β} \to j}} \} {\vert}_{{V}_{\to }^{t}}$$

is a non-backtracking matrix, and

$${t}^{} = \{ {j \to {e}_{β} , {e}_{γ} \to i}_{} \} {\vert}_{{V}_{\to }^{t}} = \{ \frac{\partial {v}_{{e}_{γ \to i}}}{\partial {v}_{j \to {e}_{β}}} \} {\vert}_{{V}_{\to }^{t}}$$

is a subcritical non-backtracking matrix. For the convenience of subsequent iterative derivation, the non-backtracking matrix [symbol] and the subcritical non-backtracking matrix [symbol] are extended to higher dimensions:

$$\{ \begin{matrix}{M}_{{e}_{β} {jie}_{γ}}^{t} = ( 1 - {n}_{i} ) {H}_{{ie}_{γ}} {H}_{j {e}_{β}} {δ}_{ij} ( 1 - {δ}_{{e}_{β} {e}_{γ}} ) {M}_{{e}_{β} {iie}_{γ}}^{t} \\ {I}_{{je}_{β} {e}_{γ} i}^{t} = {H}_{{ie}_{γ}} {H}_{j {e}_{β}} {δ}_{{e}_{β} {e}_{γ}} ( 1 - {δ}_{ij} ) {I}_{{je}_{γ} {e}_{γ} i}^{t}\end{matrix} \qquad ( 13 )$$

Where H={Hᵢₑ_{_{γ}}}_{S×S} is an adjacency matrix; when aₑ_{_{β}}_{→i,i→e}_{_{γ}}^{t}=0, Mₑ_{_{β}}ᵢᵢₑ_{_{γ}}^{t}, =1; otherwise, Mₑ_{_{β}}ᵢᵢₑ_{_{γ}}^{t}=0. Similarly, when b_{j→e}_{_{γ}}_{,e}_{_{γ}}_{→i}^{t}=m_{γ}−1, I_{j→e}_{_{γ}}ₑ_{_{γ}}_{→i}^{t}=1; otherwise, I_{j→e}_{_{γ}}ₑ_{_{γ}}_{→i}^{t}=0.

The fixed point iteration method is used to iterate formula (5) as follows:

When t=1, letting V_{→}⁰=n_{→} and V_{→}¹=n_{→}+Jg⁰×n_{→}:

$${[ \begin{matrix}{v}_{1} \\ {v}_{2}\end{matrix} ]}^{1} = [ \begin{matrix}{n}_{1} \\ 0\end{matrix} ] + [ \begin{matrix}0 & {M}^{0} \\ {I}^{0} & 0\end{matrix} ] [ \begin{matrix}{n}_{1} \\ 0\end{matrix} ] = [ \begin{matrix}{n}_{1} \\ {I}^{0} {n}_{1}\end{matrix} ] \qquad ( 14 )$$

A specific form of each element in formula (14) can be expressed as:

$$\{ \begin{matrix}{v}_{i \to {e}_{γ}}^{1} = {n}_{i} {H}_{{ie}_{γ}} \\ {v}_{{e}_{γ} \to i}^{1} = {H}_{{ie}_{γ}} {\sum }_{j} {n}_{j} {H}_{{je}_{γ}} ( 1 - {δ}_{ij} ) {I}_{{je}_{γ} {e}_{γ} i}^{0}\end{matrix} \qquad ( 15 )$$

A 1-norm of an activation probability v is used to measure a final activation scale in hypergraphs, and the following formula is obtained after collation:

$$\begin{matrix}‖ {v}_{\to } ‖ = {\sum }_{i {e}_{γ}} {v}_{i \to {e}_{γ}} + {\sum }_{i {e}_{γ}} {v}_{{e}_{γ} \to i} \\ = {\sum }_{i {e}_{γ}} {n}_{i} {H}_{i {e}_{γ}} + {\sum }_{i {e}_{γ}} {H}_{i {e}_{γ}} {\sum }_{j} {n}_{j} {H}_{j {e}_{γ}} ( 1 - {δ}_{i j} ) {I}_{j {e}_{γ} {e}_{γ} i}^{0} \\ = {\sum }_{i} {n}_{i} {k}_{j} + {\sum }_{i} {n}_{i} {\sum }_{{e}_{γ} ∈ \partial i} {\sum }_{j ∈ \partial {e}_{γ} / i} {I}_{i {e}_{γ} {e}_{γ} j}^{0} \\ = {\sum }_{i} {n}_{i} ( {k}_{j} + {\sum }_{{e}_{γ} ∈ \partial i} {\sum }_{j ∈ \partial {e}_{γ} / i} {I}_{i {e}_{γ} {e}_{γ} j}^{0} )\end{matrix} \qquad ( 16 )$$

By selecting the node i with the maximum kᵢ+Σₑ_{_{γ}}_{∈∂i}Σ_{j∈∂e}_{_{γ}}_{/i} Iᵢₑ_{_{γ}}ₑ_{_{γ}}ⱼ⁰ value as a seed, the minimum number of seed sets can be selected to realize information spread maximization. Therefore, 1-order hypergraph collective influence is defined:

$${HCI}_{1} ( i ) = {k}_{i} + {\sum }_{{e}_{γ} ∈ \partial i} {\sum }_{j ∈ \partial {e}_{γ} / i} {I}_{i {e}_{γ} {e}_{γ} j}^{0} \qquad ( 17 )$$

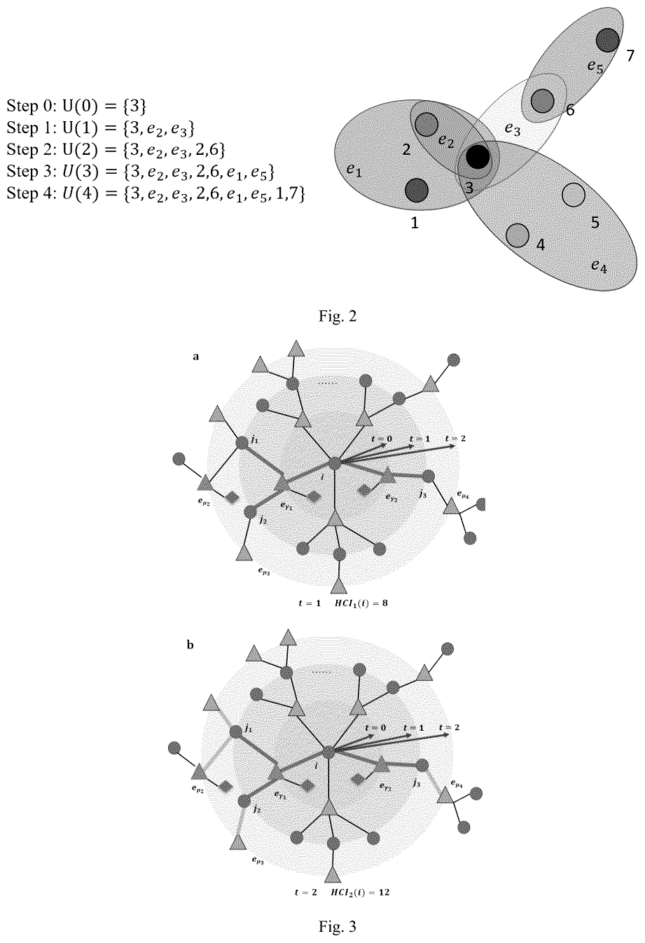

As shown in a of FIG. 2, the hyperdegree of node i is kᵢ=5, and Σₑ_{_{γ}}_{∈∂i}Σ_{j∈∂e}_{_{γ}}_{/i} Iᵢₑ_{_{γ}}ₑ_{_{γ}}ⱼ⁰=3 in the figure represents that the number of bold paths (subcritical paths) starting from the node i and having a length of 2 is 3, so the 1-order hypergraph collective influence of the node i is HCI₁(i)=8.

Using the above method, when t=2 and V_{→}²=n_{→}+Jg¹×V_{→}¹, 2-order hypergraph collective influence can be derived at this time:

$$H C {I}_{2} ( i ) = {k}_{i} + {\sum }_{{e}_{γ} ∈ \partial i} {\sum }_{j ∈ \partial {e}_{γ} / i} {I}_{i {e}_{γ} {e}_{γ} j}^{1} + {\sum }_{{e}_{γ} ∈ \partial i} {\sum }_{j ∈ \partial {e}_{γ} / i} {I}_{i {e}_{γ} {e}_{γ} j}^{0} {\sum }_{{e}_{μ} ∈ \partial j / {e}_{γ}} ( 1 - {n}_{j} ) {M}_{{e}_{γ} j j {e}_{μ}}^{1} \qquad ( 18 )$$

As shown in b of FIG. 2, the hyperdegree of node i is kᵢ=5, Σₑ_{_{γ}}_{∈∂i}Σ_{j∈∂e}_{_{γ}}_{/i} Iᵢₑ_{_{γ}}ₑ_{_{γ}}ⱼ⁰=3 in the figure represents that the number of bold paths (subcritical paths) starting from the node i and having a length of 2 is 3, and Σₑ_{_{γ}}_{∈∂i}Σ_{j∈∂e}_{_{γ}}_{/i} Iᵢₑ_{_{γ}}ₑ_{_{γ}}ⱼ⁰ Σₑ_{_{μ}}_{∈∂j/e}_{_{γ}}(1−nⱼ)Mₑ_{_{γ}}ⱼⱼₑ_{_{μ}}¹=4 in the figure represents that the number of bold paths (subcritical paths) starting from the node i and having a length of 3 is 4, so the 2-order hypergraph collective influence of the node i is HCI₁(i)=12.

Similarly, n-order hypergraph collective influence can be derived as:

$$H C {I}_{n} ( i ) = {k}_{i} + {\sum }_{L ∈ {A}_{n}} {O}_{L}^{n} + {\sum }_{L ∈ {B}_{n}} {E}_{L}^{n} \qquad ( 19 )$$

Where Aₙ={x∈N⁺|x mod 2=0,x≤n} and Bₙ={x∈N⁺|x mod 2=1,x≤n};

$$\begin{matrix}{𝕆}_{L}^{n} = {\sum }_{{e}_{γ} ∈ \partial i} {\sum }_{{i}_{1} ∈ \partial {e}_{γ} / i} {I}_{{ie}_{γ} {e}_{γ} {i}_{1}}^{n - L} {\sum }_{{e}_{{γ}_{1}} ∈ \partial {i}_{1} / {e}_{γ}} ( 1 - {n}_{{i}_{1}} ) {M}_{{e}_{γ} {i}_{1} {i}_{1} {e}_{{γ}_{1}}}^{n - L + 1} \times … \times {\sum }_{{e}_{{γ}_{ℓ}} ∈ \partial {i}_{ℓ} / {e}_{{γ}_{ℓ - 1}}} ( 1 - {n}_{{i}_{ℓ}} ) {M}_{{e}_{{γ}_{ℓ - 1}}}^{n - 1} {i}_{ℓ} {i}_{ℓ} {e}_{{γ}_{ℓ}} , \\ {𝔼}_{L}^{n} = {\sum }_{{e}_{γ} ∈ \partial i} {\sum }_{{i}_{1} ∈ \partial {e}_{γ} / i} {I}_{{ie}_{γ} {e}_{γ} {i}_{1}}^{n - L} {\sum }_{{e}_{{γ}_{1}} ∈ \partial {i}_{1} / {e}_{γ}} ( 1 - {n}_{{i}_{1}} ) {M}_{{e}_{γ} {i}_{1} {i}_{1} {e}_{{γ}_{1}}}^{n - L + 1} \times … \times {\sum }_{{i}_{ι} ∈ \partial {e}_{{γ}_{ι}} / {i}_{ι}} {I}_{{i}_{ι} {e}_{{γ}_{ι}} {e}_{{γ}_{ι}} {i}_{ι + 1}}^{n - 1} ;\end{matrix}$$

Where i₁ represents a 1-layer neighbor node of the node i; [symbol] represents an [symbol] -layer neighbor node of the node i; e_{γ}_{₁} represents a 1-layer neighbor hyperedge of the hyperedge e_{γ}; [symbol] represents an [symbol] -layer neighbor hyperedge of the hyperedge e_{γ}.

In the part of HCI-TM algorithm design and numerical simulation evaluation, firstly, a greedy algorithm for selecting a set with the maximum influence (the HCI-TM algorithm) is designed based on a hypergraph collective influence measurement method. Specific steps are as follows:
Step 1: initializing a seed set S=Ø, and calculating the n-order hypergraph collective influence HCIₙ(i) of all nodes in the hypergraph.
Step 2: selecting the node i with the maximum hypergraph collective influence as a seed, adding the seed into a seed set S={i}∪S, and then conducting spread based on the hypergraph threshold rule.
Step 3: judging whether the node activation ratio in the hypergraph exceeds aᵣ; if the node activation ratio exceeds aᵣ, the maximum influence set in this condition is S.
Step 4: if the node activation ratio does not exceed aᵣ, recalculating the n-order hypergraph collective influence HCIₙ(i) of a ┌n/2┐-layer neighbor node of an active node, updating the state of the hyperedge (active state, subcritical state and non-subcritical state, wherein the active state indicates that the hyperedge is activated, the subcritical state indicates that the hyperedge will be activated if one more node in the hyperedge is activated, and other states become the non-subcritical state), and repeating step 2 to step 3.

Secondly, robustness and effectiveness of the HCI-TM algorithm are verified on Erdös-Rényi hypergraphs with the average hyperdegrees of 2 and 3, scale-free hypergraphs with the power-law exponents of 1.5 and 2, and uniform hypergraphs with the cardinalities of hyperdegree of 4 and 5; in order to ensure the reliability, the average of 10 independent experiments is taken as an experimental result. Specific steps are as follows:
Step 1: using a configuration method to generate 10 Erdös-Rényi hypergraphs with the average hyperdegrees of 2 and 3, scale-free hypergraphs with the power-law exponents of 1.5 and 2, and uniform hypergraphs with the cardinalities of hyperdegree of 4 and 5, and the node scales of 5,000, 10,000, 20,000, 30,000, 50,000 and 100,000, respectively.
Step 2: using the HCI-TM algorithm and other contrast algorithms to select seed sets on different scales and types of hypergraphs, conducting spread based on the threshold rule, and recording the activation scale in hypergraphs at a fixed interval (ratio of seed nodes).
Step 3: making a comparison with other algorithms to evaluate the effectiveness of the HCI-TM algorithm: when a same ratio of seed nodes is selected, the algorithm with a larger activation scale in hypergraphs is more effective.

FIG. 3 shows the performance of the HCI-TM algorithm and other algorithms (high degree algorithm (HD), high degree adaptive algorithm (HDA), neighbor preference algorithm (NP), neighbor preference adaptive algorithm (NPA), PageRank algorithm (PR) and Random algorithm (RA)) on different scales and types of Erdös-Rényi hypergraphs, scale-free hypergraphs and uniform hypergraphs; the performance of the HCI-TM algorithm is better than that of other algorithms, and fewer seed nodes can be selected to achieve a larger activation range. At the same time, a 2-order HCI-TM algorithm is superior to a 1-order algorithm, which proves that a higher-order HCI-TM algorithm has better performance. The robustness and practicality of the HCI-TM algorithm are verified.

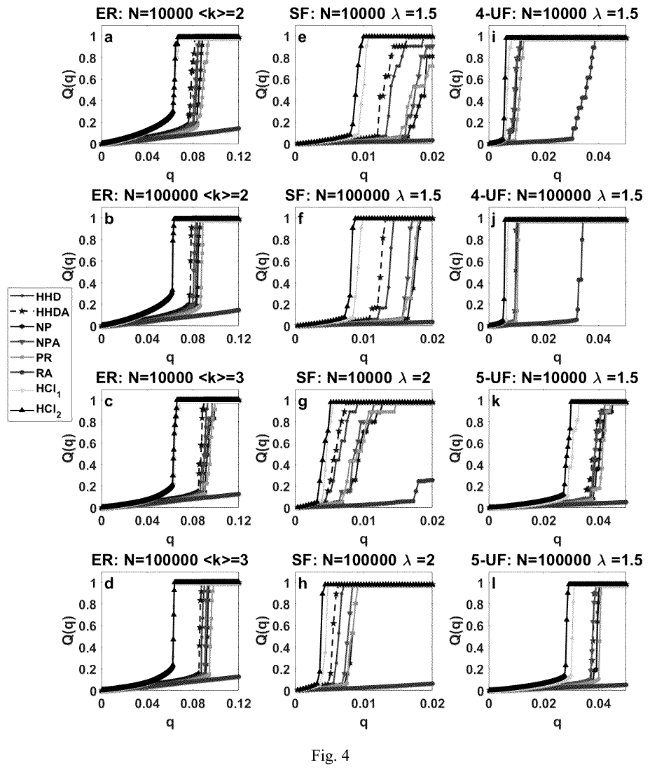

Recording operating time of different algorithms on Erdös-Rényi hypergraphs with the average hyperdegrees of 2 and 3, scale-free hypergraphs with the power-law exponents of 1.5 and 2, and uniform hypergraphs with the cardinalities of hyperdegree of 4 and 5, and the node scales of 5,000, 10,000, 20,000, 30,000, 50,000 and 100,000, respectively. Taking log₁₀ N as the horizontal axis (N is hypergraph scale). Each vertical axis is log₁₀ T, where T is the operating time. The broken line graph shown in FIG. 4 is drawn and is processed by one order polynomial fitting. It is found that the time complexity of the HCI-TM algorithm is near linear in actual operation.

Finally, an evolution relationship of the maximum HCI value in a seed selection process is analyzed on the Erdös-Rényi hypergraph with the average hyperdegree of 3, the scale-free hypergraph with the power-law exponent of 1.5, and the uniform hypergraph with the cardinality of hyperdegree of 5, and the node scale of 10,000. It is verified that the index of hypergraph collective influence can be used as a criterion for predicting the occurrence of cascade phenomenon. Specific steps thereof are as follows:
Step 1: using the HCI-TM algorithm to select the seed nodes on the hypergraphs, and recording the HCI value of the selected seed nodes (the maximum HCI value in the hypergraphs at the moment).
Step 2: analyzing the figure of the evolution of the HCI value with the selection of the seed nodes, the index of HCI can be used as a criterion for the occurrence of cascade phenomenon: the peak value of HCI is corresponding to a phase transformation point where the cascade phenomenon occurs; by observing the evolution of the maximum HCI value in the hypergraphs, whether and when explosive information spread (the cascade phenomenon) will occur in a hypergraph spreading process can be judged.

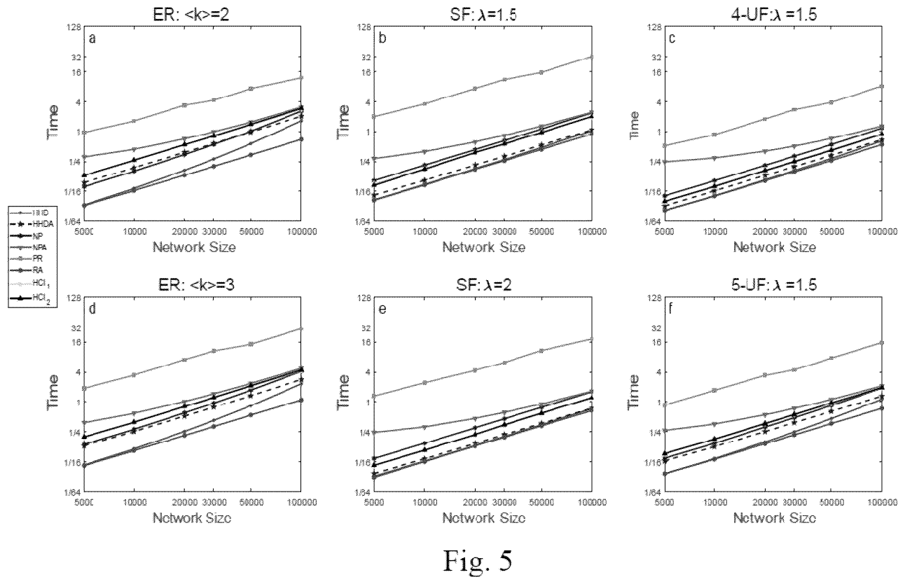

In the figure of the evolution of the maximum HCI value in hypergraphs with the selection of seeds, as shown in FIG. 5, each horizontal axis represents the number of seed nodes, and each vertical axis represents the maximum HCI value in the hypergraphs at the moment. Compared with FIG. 3, it is found that the peak value of hypergraph collective influence (HCI) is corresponding to a phase transformation point where the cascade phenomenon occurs, and an emergent behavior is induced by the cascade phenomenon among the nodes in the hypergraphs; therefore, the index of hypergraph collective influence can be used as an effective criterion for the occurrence of emergent phenomenon. At the same time, the peak advance of the 2-order hypergraph collective influence and the 1-order hypergraph collective influence also confirm that the higher-order HCI-TM algorithm has a better effect.

In the part of algorithm application study, the marketing network is taken as an example, the hypergraph threshold model is used to simulate spread of reputation among customers, and the HCI-TM algorithm is applied to the real scenario of the marketing network (the Las Vegas bar review dataset) to identify a most recommendable customer set in the marketing network.
Step 1: modeling a hypergraph, wherein the hypergraph is constructed by intercepting Las Vegas bar review for one month from Yelp Kaggle competition data. The hypergraph has 1,234 nodes and 1,194 hyperedges, wherein the nodes represent customers, and the hyperedges represent different cocktail categories. If a customer reviews a cocktail, an incidence relationship exists between the customer (a node) and the cocktail (a hyperedge).
Step 2: using the hypergraph threshold model to simulate the spread of customer reputation in a marketing network, and setting a hyperedge threshold to 0.6 according to the principle of majority rule, i.e., among reviews of a cocktail, if 60% of customer reviews are positive, the cocktail is considered recommended, and the overall customer rating of the bar will also become positive.
Step 3: using the HCI-TM algorithm to screen out the most recommendable customer group for popularization, drawing a diagram of relationships between the ratio of selected recommendable groups and the ratio of customers with positive reviews, and making a comparison with other algorithms.
Step 4: evaluating the effect of the algorithms, and selecting a same number of recommendable customers for popularization; the higher the ratio of customers with positive reviews is, the better the effect of an algorithm is, the more the marketing cost can be saved.

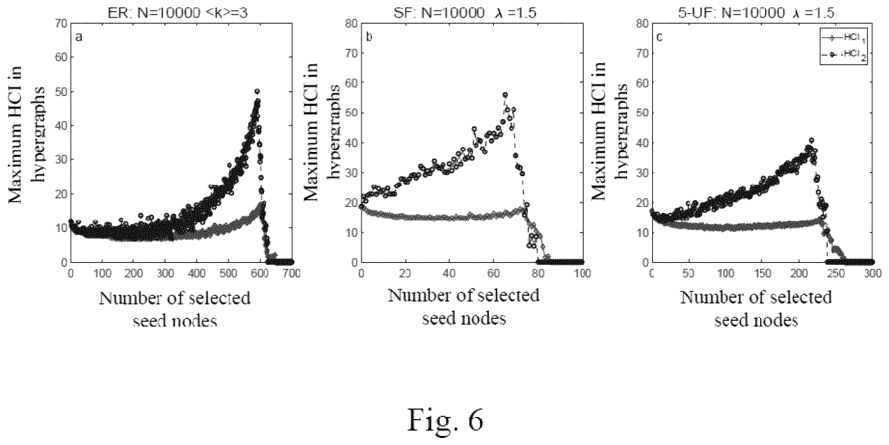

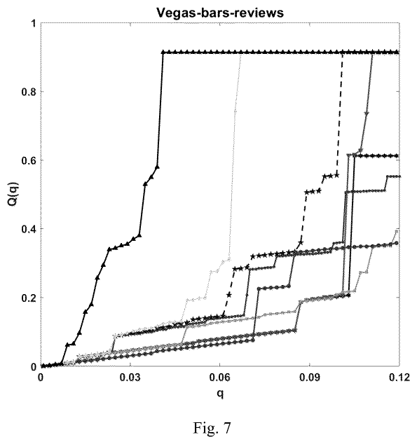

The performance of the HCI-TM algorithm and other contrast algorithms on the Las Vegas bar review dataset is shown in FIG. 6. The HCI1-TM algorithm and a HCI2-TM algorithm only need to select 82 and 49 customers for popularization, and the ratio of customers with positive reviews can reach 90%. To achieve the above goals, a HHDA algorithm and the NPA algorithm need to select 124 and 136 customers for popularization, respectively. The HCI-TM algorithm can be used for accurately identifying the most recommendable customer group, which is of great significance for reducing the marketing cost.

The above-mentioned technical solution only reflects a preferred technical solution of technical solutions of the present invention. Some changes made to certain parts by those skilled in the art all reflect the principle of the present invention, and belong to the protective scope of the present invention.

1. A method for identifying an optimal influence customer group in a marketing network based on a hypergraph threshold model, comprising the following steps:
step 1: establishing a hypergraph threshold model based on sales data first;
step 2: using the hypergraph threshold model to simulate spread of customer reputation in a marketing network, and setting a hyperedge threshold according to a specific scenario;
step 3: using an HCI-TM algorithm to screen out a most recommendable customer group for popularization, and using a hypergraph threshold rule to simulate spread of information among customers.

2. The method for identifying an optimal influence customer group in a marketing network based on a hypergraph threshold model according to claim 1, wherein a process of establishing the hypergraph threshold model in step 1 is as follows:
in the hypergraph threshold model, a node represents a customer, a hyperedge represents an interaction relationship between the customer and a product, and one hyperedge represents an interaction relationship between all customers who have evaluated a certain product and the product; a specific rule of the hypergraph threshold model is that when the node activation ratio in the hyperedge exceeds the hyperedge threshold, the hyperedge will be activated; when the hyperedge is activated, all nodes in the hyperedge will be activated;
a Cavity method is used to establish a conditional probability self-satisfying equation based on the hypergraph threshold rule, thus to weaken strong correlation between the nodes and the hyperedge and accurately describe an information spreading rule in a hypergraph; the self-satisfying equation described in a tree-like hypergraph is expressed as formula (1), i.e., a condition for activating a node i is that: the node will be activated when any hyperedge incident with the node other than a hyperedge e_{γ} is activated, and a condition for activating the hyperedge e_{γ} is that: the hyperedge will be activated when any m_{γ} nodes incident with the hyperedge e_{γ} other than the node i are activated:
$$\{ \begin{matrix}{v}_{i \to {e}_{γ}} = {n}_{i} + ( 1 - {n}_{i} ) [ 1 - {\prod }_{{e}_{β} ∈ \partial {ile}_{γ}} ( 1 - {v}_{{e}_{β} \to i} ) ] \\ {v}_{{e}_{γ} \to i} = 1 - {\prod }_{{P}_{h} ∈ {P}_{{e}_{γ} li}^{{m}_{γ}}} ( 1 - {\prod }_{p ∈ {P}_{h}} {v}_{p \to {e}_{γ}} )\end{matrix} \qquad ( 1 )$$
in formula (1), v_{i→e}_{_{γ}} represents the probability that the node i is activated when the hyperedge e_{γ} is removed, and vₑ_{_{γ}}_{→i} represents the probability that the hyperedge e_{γ} is activated when the node i is removed; ∂i/e_{γ}=represents a set composed of hyperedges incident with the node i other than the hyperedge e_{γ}; a set of all combinatorial numbers composed of m_{γ} nodes in the hyperedge e_{γ} other than the node i is Pₑ_{_{γ}}_{/i}^{m}^{_{γ}}, Pₑ_{_{γ}}_{/i}^{m}^{_{γ}}={P₁, P₂, . . . , P_{τ}}, where τ=Cₙ_{_{γ}}₋₁^{m}^{_{γ}}, Pₕ∈Pₑ_{_{γ}}_{/i}^{m}^{_{γ}} and Pₕ={Pₕ₁, Pₕ₂, . . . , Pₕₘ_{_{γ}}} represents a set composed of m_{γ} nodes; nᵢ represents whether the node i is a seed node; when the node is a seed node, nᵢ=1; otherwise, nᵢ=0;
final states of the node i and the hyperedge e_{γ} can be calculated by the following formula:
$$\{ \begin{matrix}{v}_{i} = {n}_{i} ( 1 - {n}_{i} ) [ 1 - {\prod }_{{e}_{β} ∈ \partial i} ( 1 - {v}_{{e}_{β} \to 1} ) ] \\ {v}_{{e}_{γ}} = 1 - {\prod }_{{P}_{h} ∈ {P}_{{e}_{γ}}^{{m}_{γ}}} ( 1 - {\prod }_{p ∈ {P}_{h}} {v}_{p \to {e}_{γ}} )\end{matrix} \qquad ( 2 )$$
in formula (2), vᵢ represents the final state of the node i, and vₑ_{_{γ}} represents the final state of the hyperedge e_{γ}.

3. The method for identifying an optimal influence customer group in a marketing network based on a hypergraph threshold model according to claim 1, wherein a method for calculating hypergraph collective influence is as follows:
to simplify formula (1), letting V_{→}={v₁, V₂}^{T}, where v₁={v_{i→e}_{_{γ}}}_{S×1}, and v₂={v_{i→e}_{_{γ}}}_{S×1}; S=Σᵢ₌₁^{N} kᵢ represents the sum of hyperdegrees of all nodes; similarly, n is popularized to higher dimensions
$${n}_{\to } = {( {n}_{1} , 0 )}^{T} = {( {\underbrace{… , \overbrace{{n}_{i} , … , {n}_{i} ,} …}}_{S}^{{k}_{i}} , {\underbrace{0 , … , 0}}_{S}^{} )}^{T} \qquad ( 3 )$$
therefore, formula (1) can be simplified as:
$${V}_{\to } = {n}_{\to } + G ( {V}_{\to } ) ⇔ \{ \begin{matrix}{v}_{1} = {n}_{1} + {g}_{1} ( {v}_{2} ) \\ {v}_{2} = 0 + {g}_{2} ( {v}_{1} )\end{matrix} \qquad ( 4 )$$
where g₁(v₂) represents a nonlinear function of v₂, and g₂(v₁) represents a nonlinear function of v₁;
as formula (4) is composed of complex nonlinear equations, which cannot be solved directly, linearization and a fixed point iteration method are used to solve formula (4):
$${V}_{\to }^{t + 1} = {n}_{\to } + J G {\vert}_{{V}_{\to }^{t}} \times {V}_{\to }^{t} \qquad ( 5 )$$
where V_{→}^{t} represents a state of V_{→} when the number of iteration steps is t;
a specific form of a Jacobian matrix J [symbol] |_{V}_{_{→}}_{^{t}}, is solved as follows:
$$J 𝒢 = {( \begin{matrix}\frac{\partial {g}_{1}}{\partial {v}_{1}} & \frac{\partial {g}_{1}}{\partial {v}_{2}} \\ \frac{\partial {g}_{2}}{\partial {v}_{1}} & \frac{\partial {g}_{2}}{\partial {v}_{2}}\end{matrix} )}_{2 S \times 2 S} \qquad ( 6 )$$
a partial derivative of g₁ is calculated:
$$\frac{\partial {v}_{j \to {e}_{γ}}}{\partial {v}_{j \to {e}_{β}}} = 0 \qquad ( 7 )$$
$$\frac{\partial {v}_{i \to {e}_{γ}}}{\partial {v}_{{e}_{β} \to j}} {\vert}_{{v}_{\to }^{t}} = \{ \begin{matrix}1 - {n}_{i} & i = j , {e}_{β} \neq {e}_{γ} , {a}_{{e}_{β} \to i , i \to {e}_{γ}}^{t} = 0 \\ 0 & otherwise\end{matrix} \qquad ( 8 )$$
where aₑ_{_{β}}_{→i,i→e}_{_{γ}}^{t}=Σₑ_{_{μ}}_{∈∂i/(e}_{_{γ}}_{,e}_{_{β}}₎vₑ_{_{μ}}_{→i}^{t};
a partial derivative of g₂ is calculated as follows:
$$\frac{\partial {v}_{{e}_{γ} \to i}}{\partial {v}_{{e}_{β} \to j}} = 0 \qquad ( 9 )$$
when e_{β}=e_{γ}, j≠i:
$$\frac{\partial {v}_{{e}_{γ} \to i}}{\partial {v}_{j \to {e}_{γ}}} = {{\prod }_{{P}_{h} ∈ {P}_{{e}_{γ} li}^{{m}_{γ}}}}_{j ∉ {P}_{h}} ( 1 - {\prod }_{p ∈ {P}_{h}} {v}_{p \to {e}_{γ}} ) {{\sum }_{{P}_{h} ∈ {P}_{{e}_{γ} li}^{{m}_{γ}}}}_{j ∈ {P}_{h}} [ {\prod }_{p ∈ {P}_{h} / j} {v}_{p \to {e}_{γ}} {{{\prod }_{{\tilde{P}}_{h} ∈ {P}_{{e}_{γ} li}^{{m}_{γ}}}}_{{\tilde{P}}_{h} \neq {P}_{h}}}_{j ∈ {\tilde{P}}_{h}} ( 1 - {\prod }_{p ∈ {\tilde{P}}_{h}} {v}_{p \to {e}_{γ}} ) ] \qquad ( 10 )$$
where \tilde{P}ₕ∈Pₑ_{_{γ}}_{/i}^{m}^{_{γ}} and \tilde{P}ₕ≠Pₕ;
letting b_{j→e}_{_{γ}}_{,e}_{_{γ}}_{→i}^{t}=Σ_{p∈∂e}_{_{γ}}_{/(i,j)}v_{p→e}_{_{γ}}^{t} represent the number of nodes activated at time t in e_{γ} after nodes i and j are removed; when b_{j→e}_{_{γ}}_{,e}_{_{γ}}_{→i}^{t}≥m_{γ}, Π_{p∈P}_{ₕ} v_{p→e}_{_{γ}}=1 certainly exists, so
$$\frac{\partial {v}_{{e}_{γ} \to i}}{\partial {v}_{j \to {e}_{γ}}} = 0 ;$$
when b_{j→e}_{_{γ}}_{,e}_{_{γ}}_{→i}^{t}≤m_{γ}−2, any Π_{p∈P}_{ₕ} v_{p→e}_{_{γ}} is 0, so
$$\frac{\partial {v}_{{e}_{γ} \to i}}{\partial {v}_{j \to {e}_{γ}}} = 0 ;$$
when b_{j→e}_{_{γ}}_{,e}_{_{γ}}_{→i}^{t}≤m_{γ}−1, exactly and only one combination makes Π_{p∈P}_{ₕ}_{/j} v_{p→e}_{_{γ}}=1 then
$${\prod }_{{{\tilde{P}}_{h} ∈ {P}_{{e}_{γ} / i}^{{m}_{y}}}_{{{\tilde{P}}_{h} \neq {P}_{h}}_{j ∈ {\tilde{P}}_{h}}}} ( 1 - {\prod }_{p ∈ {P}_{h}} {v}_{p \to {e}_{γ}} ) = 1 , {\prod }_{{{\tilde{P}}_{h} ∈ {P}_{{e}_{γ} / i}^{{m}_{y}}}_{j ∉ {P}_{h}}} ( 1 - {\prod }_{{P}_{h} ∈ {P}_{h}} {v}_{p \to {e}_{γ}} ) = 1 , so \frac{\partial {v}_{{e}_{γ} \to i}}{\partial {v}_{j \to {e}_{γ}}} = 1 ;$$
therefore:
$$\frac{\partial {v}_{{e}_{γ} \to i}}{\partial {v}_{j \to {e}_{β}}} {\vert}_{{V}_{\to }^{t}} = \{ \begin{matrix}1 & {e}_{β} = {e}_{γ} , j \neq i , {b}_{j \to {e}_{γ} , {e}_{γ} \to i}^{t} = {m}_{γ} - 1 \\ 0 & otherwise\end{matrix} \qquad ( 11 )$$
as a result, the specific form of the Jacobian matrix J [symbol] |_{V}_{_{→}}_{^{t}} is:
$$JG {\vert}_{{V}_{\to }^{t}} = ( \begin{matrix}0 & {M}^{t} \\ {I}^{t} & 0\end{matrix} ) \qquad ( 12 )$$
where
$${ℳ}^{t} = \{ {ℳ}_{{e}_{β} \to j , i \to {e}_{γ}}^{t} \} = \{ \frac{\partial {v}_{i \to {e}_{γ}}}{\partial {v}_{{e}_{β} \to j}} \} {\vert}_{{V}_{\to }^{t}}$$
is a non-backtracking matrix, and
$${𝒥}^{t} = \{ {𝒥}_{j \to {e}_{β} , {e}_{γ} \to i} \} {\vert}_{{V}_{\to }^{t}} = \{ \frac{\partial {v}_{{e}_{γ} \to i}}{\partial {v}_{j \to {e}_{β}}} \} {\vert}_{{V}_{\to }^{t}}$$
is a subcritical non-backtracking matrix; for the convenience of subsequent iterative derivation, the non-backtracking matrix [symbol] and the subcritical non-backtracking matrix [symbol] are extended to higher dimensions:
$$\{ \begin{matrix}{M}_{{e}_{β} {jie}_{γ}}^{t} = ( 1 - {n}_{i} ) {H}_{{ie}_{γ}} {H}_{{je}_{β}} {δ}_{ij} ( 1 - {δ}_{{e}_{β} {e}_{γ}} ) {M}_{{e}_{β} {iie}_{γ}}^{t} \\ {I}_{{je}_{β} {e}_{γ} i}^{t} = {H}_{{ie}_{γ} {H}_{{je}_{β}}} {δ}_{{e}_{β} {e}_{γ}} ( 1 - {δ}_{ij} ) {I}_{{je}_{γ} {e}_{γ} i}^{t}\end{matrix} \qquad ( 13 )$$
where [symbol] represents an element with a subscript (e_{γ}, j, i, e_{γ}) in a 4-dimensional tensor { [symbol] }_{M×N×N×M}; when i=j, δᵢⱼ=1; otherwise, δᵢⱼ=0; [symbol] represents an element with a subscript (j, e_{β}, e_{γ}, i) in a 4-dimensional tensor { [symbol] }_{N×M×M×N}; H={Hᵢₑ_{_{γ}}}_{S×S} is an incidence matrix; when the node i is incident with the hyperedge e_{γ}, Hᵢₑ_{_{γ}}=1; otherwise, Hᵢₑ_{_{γ}}=0; when aₑ_{_{β}}_{→i,i→e}_{_{γ}}^{t}=0, Mₑ_{_{β}}ₗᵢₑ_{_{γ}}^{t}=1; otherwise, Mₑ_{_{β}}ₗᵢₑ_{_{γ}}^{t}=0; similarly, when b_{j→e}_{_{γ}}_{,e}_{_{γ}}_{→i}^{t}=m_{γ}−1, I_{j→e}_{_{γ}}ₑ_{_{γ}}_{→i}^{t}=1; otherwise, I_{j→e}_{_{γ}}ₑ_{_{γ}}_{→i}^{t}=0;
the fixed point iteration method is used to iterate formula (5) as follows:
when t=1, letting V_{→}⁰=n_{→} and V_{→}¹=n_{→}+J [symbol] ×n_{→}:
$${[ \begin{matrix}{v}_{1} \\ {v}_{2}\end{matrix} ]}^{1} = [ \begin{matrix}{n}_{1} \\ 0\end{matrix} ] + [ \begin{matrix}0 & {M}^{0} \\ {I}^{0} & 0\end{matrix} ] [ \begin{matrix}{n}_{1} \\ 0\end{matrix} ] = [ \begin{matrix}{n}_{1} \\ {I}^{0} {n}_{1}\end{matrix} ] \qquad ( 14 )$$
a specific form of each element in formula (14) can be expressed as:
$$\{ \begin{matrix}{v}_{i \to {e}_{γ}}^{1} = {n}_{i} {H}_{{ie}_{γ}} \\ {v}_{{e}_{γ} \to i}^{1} = {H}_{{ie}_{γ}} {\sum }_{j} {n}_{j} {H}_{{je}_{γ}} ( 1 - {δ}_{ij} ) {I}_{{je}_{γ} {e}_{γ} i}^{0}\end{matrix} \qquad ( 15 )$$
a 1-norm of an activation probability v is used to measure a final activation scale in hypergraphs, and the following formula is obtained after collation:
$$\begin{matrix}‖ {v}_{\to } ‖ = {\sum }_{{ie}_{γ}} {v}_{i \to {e}_{γ}} + {\sum }_{i {e}_{γ}} {v}_{{e}_{γ} \to i} \\ = {\sum }_{{ie}_{γ}} {n}_{i} {H}_{{ie}_{γ}} + {\sum }_{{ie}_{γ}} {H}_{{ie}_{γ}} {\sum }_{j} {n}_{j} {H}_{{je}_{γ}} ( 1 - {δ}_{ij} ) {I}_{{je}_{γ} {e}_{γ} i}^{0} \\ = {\sum }_{i} {n}_{i} {k}_{i} + {\sum }_{i} {n}_{i} {\sum }_{{e}_{γ} ∈ \partial i} {\sum }_{j ∈ \partial {e}_{γ} / i} {I}_{{ie}_{γ} {e}_{γ} j}^{0} \\ = {\sum }_{i} {n}_{i} ( {k}_{i} + {\sum }_{{e}_{γ} ∈ \partial i} {\sum }_{j ∈ \partial {e}_{γ} / i} {I}_{i {e}_{γ} {e}_{γ} j}^{0} )\end{matrix} \qquad ( 16 )$$
by selecting the node i with the maximum kᵢ+Σₑ_{_{γ}}_{∈∂i}Σ_{j∈∂e}_{_{γ}}_{/i} Iₑ_{_{γ}}ₑ_{_{γ}}ⱼ⁰ value as a seed, the minimum number of seed sets can be selected to realize information spread maximization; therefore, 1-order hypergraph collective influence is defined:
$${HCI}_{1} ( i ) = {k}_{i} + {\sum }_{{e}_{γ} ∈ \partial i} {\sum }_{j ∈ \partial {e}_{γ} / i} {I}_{{ie}_{γ} {e}_{γ} j}^{0} \qquad ( 17 )$$
using the above method, when t=2 and V_{→}²=n_{→}+J [symbol] ×V_{→}¹, 2-order hypergraph collective influence can be derived:
$${HCI}_{2} ( i ) = {k}_{i} + {\sum }_{{e}_{γ} ∈ \partial i} {\sum }_{j ∈ \partial {e}_{γ} / i} {I}_{{ie}_{γ} {e}_{γ} j}^{1} + {\sum }_{{e}_{γ} ∈ \partial i} {\sum }_{j ∈ \partial {e}_{γ} / i} {I}_{{ie}_{γ} {e}_{γ} j}^{0} {\sum }_{{e}_{μ} ∈ \partial j / {e}_{γ}} ( 1 - {n}_{j} ) {M}_{{e}_{γ} {jje}_{μ}}^{1} \qquad ( 18 )$$
similarly, n-order hypergraph collective influence can be derived as:
$${HCI}_{n} ( i ) = {k}_{i} + {\sum }_{L ∈ {A}_{n}} {O}_{L}^{n} + {\sum }_{L ∈ {B}_{n}} {E}_{L}^{n} \qquad ( 19 )$$
where Aₙ={x∈N⁺|x mod 2=0,x≤n} and Bₙ={x∈N⁺|x mod 2=1,x≤n};
$$\begin{matrix}{𝕆}_{L}^{n} = {\sum }_{{e}_{γ} ∈ \partial i} {\sum }_{{i}_{1} ∈ \partial {e}_{γ} / i} {I}_{{ie}_{γ} {e}_{γ} {i}_{1}}^{n - L} {\sum }_{{e}_{{γ}_{1}} ∈ \partial {i}_{1} / {e}_{γ}} ( 1 - {n}_{{i}_{1}} ) {M}_{{e}_{γ} {i}_{1} {i}_{1} {e}_{{γ}_{1}}}^{n - L + 1} \times … \times {\sum }_{{e}_{{γ}_{ℓ}} ∈ \partial {i}_{ℓ} / {e}_{{γ}_{ℓ - 1}}} ( 1 - {n}_{{i}_{ℓ}} ) {M}_{{e}_{{γ}_{ℓ - 1}}}^{n - 1} {i}_{ℓ} {i}_{ℓ} {e}_{{γ}_{ℓ}} , \\ {𝔼}_{L}^{n} = {\sum }_{{e}_{γ} ∈ \partial i} {\sum }_{{i}_{1} ∈ \partial {e}_{γ} / i} {I}_{{ie}_{γ} {e}_{γ} {i}_{1}}^{n - L} {\sum }_{{e}_{{γ}_{1}} ∈ \partial {i}_{1} / {e}_{γ}} ( 1 - {n}_{{i}_{1}} ) {M}_{{e}_{γ} {i}_{1} {i}_{1} {e}_{{γ}_{1}}}^{n - L + 1} \times … \times {\sum }_{{i}_{ι} ∈ \partial {e}_{{γ}_{ι}} / {i}_{ι}} {I}_{{i}_{ι} {e}_{{γ}_{ι}} {e}_{{γ}_{ι}} {i}_{ι + 1}}^{n - 1} ;\end{matrix}$$
where i₁ represents a 1-layer neighbor node of the node i; [symbol] represents an [symbol] -layer neighbor node of the node i; e_{γ1} represents a 1-layer neighbor hyperedge of the hyperedge e_{γ}; [symbol] represents an [symbol] -layer neighbor hyperedge of the hyperedge e_{γ}.

4. The method for identifying an optimal influence customer group in a marketing network based on a hypergraph threshold model according to claim 1, wherein a design method of the HCI-TM algorithm in step 3 is as follows:
step 1: initializing a seed set S=Ø, and calculating the n-order hypergraph collective influence HCIₙ(i) of all nodes in the hypergraph;
step 2: selecting the node i with the maximum n-order hypergraph collective influence as a seed, adding the seed into a seed set S={i}∪S, and then conducting spread based on the hypergraph threshold rule;
step 3: judging whether the node activation ratio in the hypergraph exceeds aᵣ; if the node activation ratio exceeds aᵣ, the maximum influence set in this condition is S;
step 4: if the node activation ratio does not exceed aᵣ, recalculating the n-order hypergraph collective influence HCIₙ(i) of a ┌n/2┐-layer neighbor node of an active node, and repeating step 2 to step 3.
